(19) United States
(12) Patent Application Publication
(10) Pub. No.: US 2014/0075028 A1
(43) Pub. Date: Mar. 13, 2014

(54) Centralized Data Provisioning

(71) Applicants: Ari J. Welner, Edison, NJ (US); Kevin E. Charleston, Huntersville, NC (US); Farid Moussavi, New York, NY (US); Rodney M. Trueba, Smyrna, GA (US)

(72) Inventors: Ari J. Welner, Edison, NJ (US); Kevin E. Charleston, Huntersville, NC (US); Farid Moussavi, New York, NY (US); Rodney M. Trueba, Smyrna, GA (US)

(73) Assignee: Bank of America Corporation, Charlotte, NC (US)

(21) Appl. No.: 13/608,523

(22) Filed: Sep. 10, 2012

(51) Int. Cl. G06F 15/173

(52) U.S. Cl. 709/226

(57) ABSTRACT

In certain embodiments, a system for provisioning data on a network includes a sole provisioning platform for requests for data attributes maintained by a plurality of databases operable to receive criteria describing data quality requirements for a data attribute category, receive a data attribute in the data attribute category from one of the plurality of databases, determine whether the received data attribute complies with the data quality requirements, designate the data attribute as authorized for provisioning in response to determining that the data attribute complies with the data quality requirements, designate the data attribute as unauthorized for provisioning in response to determining that the data attribute does not comply with the data quality requirements, receive a request to provision a data attribute value from the data attribute, and provision the data attribute value in response to the data request if the data attribute is designated as authorized for provisioning.

### TECHNICAL FIELD OF THE INVENTION

This invention relates generally to data provisioning, and specifically to centralized data provisioning within a network.

### BACKGROUND OF THE INVENTION

Enterprises often maintain large information technology (IT) systems that comprise a plurality of databases accessible by various data consumers. Each database may be maintained by different asset management systems that have different data quality requirements. In a traditional environment, data consumers must request data attributes from each of the plurality of databases. In certain circumstances, different databases maintain the same, or similar, data attributes in different formats. Data consumers may receive different data attribute values depending on which database is queried. Because of this structure, IT systems must also support redundant data attributes and data attribute values held on the plurality of databases.

### SUMMARY OF THE INVENTION

According to embodiments of the present disclosure, disadvantages and problems associated with provisioning data may be reduced or eliminated.

In certain embodiments, a system for provisioning data on an electronic communication network includes a sole provisioning platform for requests for data attributes maintained by a plurality of databases, the provisioning platform operable to receive criteria describing data quality requirements for a data attribute category, receive a data attribute in the data attribute category from one of the plurality of databases, determine whether the received data attribute complies with the data quality requirements, designate the data attribute as authorized for provisioning in response to determining that the data attribute complies with the data quality requirements, designate the data attribute as unauthorized for provisioning in response to determining that the data attribute does not comply with the data quality requirements, receive a request to provision a data attribute value from the data attribute, and provision the data attribute value in response to the data request if the data attribute is designated as authorized for provisioning.

Certain embodiments of the present disclosure may include some, all, or none of the following advantages. One or more other technical advantages may be readily apparent to those skilled in the art from the figures, descriptions, and claims included herein.

In an embodiment, a single provisioning platform receives criteria describing a common data model for categories of data attributes maintained by different sources-of-record (SORB), thereby conserving the computational resources, memory, and bandwidth consumed by provisioning from data attributes that have not been standardized to a common data model.

In another embodiment, a single provisioning platform enforces a common data model by only provisioning from data attributes that satisfy the data quality requirements of the common data model, thereby conserving the computational resources, memory, and bandwidth consumed by provisioning from data attributes that do not satisfy the data quality requirements.

In yet another embodiment, a single provisioning platform enforces a common data model for provisioning from data attributes that includes rules for reconciling multiple data attributes (or data attribute values) that satisfy the data quality requirements of the common data model, thereby conserving the computational resources, memory, and bandwidth consumed by provisioning from different versions of data attributes.

In a further embodiment, a single provisioning platform is operable to identify and correct SORs that maintain unauthorized versions of data , thereby conserving the computational resources, memory, and bandwidth consumed by maintaining and provisioning from unauthorized versions of data attributes.

In a still further embodiment, a single provisioning platform is operable to evaluate the competency of SORs to satisfy data quality requirements to identify SORs in need of replacement, thereby conserving the computational resources, memory, and bandwidth consumed by maintaining SOR platforms that do not satisfy data quality requirements.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 is a block diagram illustrating an embodiment of a system for providing centralized data provisioning;

FIG. 2 is a block diagram illustrating an embodiment of a platform for providing centralized data provisioning;

FIG. 3 is a block diagram illustrating an embodiment of a system for selecting and provisioning data attribute values to data consumers;

FIG. 4 is a block diagram illustrating an embodiment of a system for identifying and correcting unauthorized data attributes;

FIG. 5 is a block diagram illustrating an embodiment of a system for identifying databases that can be eliminated or replaced; and

FIG. 6 is a flow chart of an embodiment of a method for providing centralized data provisioning.

### DETAILED DESCRIPTION OF THE INVENTION

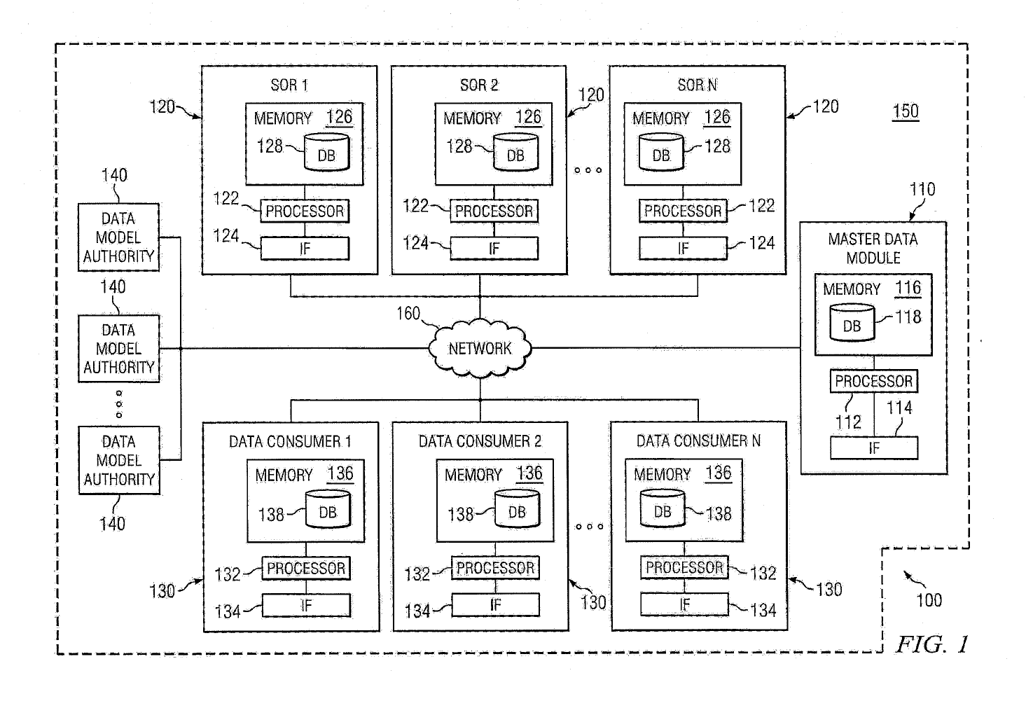

Embodiments of the present invention and its advantages are best understood by referring to FIGS. 1 through 6 of the drawings, like numerals being used for like and corresponding parts of the various drawings.

In an example, a system for providing centralized provisioning comprises a master data module, a plurality of sources-of-record (SORs), a plurality of data consumers, one or more data model authorities, an enterprise, and a network. Data attributes represent categories of data that include data attribute values that may be provisioned to data consumers 130. Data attributes may include any component of a database in SORs 120, for example, a spreadsheet, a row, column, cell, or a portion of any of the preceding. Data attribute values represent any value stored in a data attribute. The master data module receives criteria describing data quality requirements for a common data model for data attributes maintained by the SORs from data model authorities. A common data model represents a standardized data attribute format, and includes data quality requirements that describe information that must be maintained with respect to data attribute values. The master data module identifies best available data attributes (or data attribute values) in the SORs using criteria from the common data model and designates the best available data attributes (or data attribute values) as authorized for provisioning. Data consumers request data attribute values from the master data module and the master data module provisions data attribute values from authorized data attributes to the data consumers in response to the requests. The master data module may represent the sole provisioning platform for the SORs, thereby ensuring that all provisioned data attribute values satisfy the common data model and are authorized for provisioning. Thus, the master data module ensures consistent provisioning of data attribute values to all data consumers.

The master data module can identify unauthorized data attributes in SORs and correct the unauthorized data attributes with authorized data attributes. The master data module may correct the unauthorized data attributes by replacing the unauthorized data attributes with authorized data attributes, instructing SORs with unauthorized data attributes to change the unauthorized data attributes to conform with corresponding authorized data attributes, or any other suitable process. In certain situations, the master data module identifies SORs that maintain duplicative data attribute values and evaluates the competency of the SORs to satisfy certain data quality requirements. SORs that do not satisfy the data quality requirements may be identified for replacement.

FIG. 1 is a block diagram illustrating an embodiment of a system for providing centralized data provisioning. According to an embodiment, system 100 includes master data module 110, sources-of-record (SORs) 120, data consumers 130, data model authorities 140, enterprise 150, and network 160. Components of system 100, for example master data module 110, SORs 120, data consumers 130, and data model authorities 140, may be communicatively coupled by network 160. In certain embodiments, any component of system 100 can communicate with one or more other components of system 100.

Master data module 110 represents a component of system 100 that provides centralized data provisioning for network 160 (e.g., a data provisioning platform). In an embodiment, master data module 110 receives criteria describing a common data model for data attributes from data model authorities 140. Master data module 110 may evaluate data attributes maintained by SORs 120 with criteria described by the common data model to select the best data attributes available from SORs 120. In certain embodiments, master data module 110 designates selected data attributes as authorized data attributes for provisioning. For example, master data module 110 may designate data attributes as authorized in metadata for the data attributes. In an embodiment, master data module 110 selects portions of different versions of a data attribute and integrates the selected portions to generate a data attribute that represents the best available data.

Master data module 110 may provide a centralized point for provisioning data attribute values from SORs 120. In certain embodiments, master data module 110 represents the sole provisioning platform for data attribute values maintained by SORs 120 and data consumers 130 can only access data attribute values maintained by SORs 120 by requesting the data attribute values from master data module 110. Master data module 110 may include a common set of interfaces for data consumers 130. In an embodiment, master data module 110 only provisions read-only versions of data attribute values.

Master data module 120 may be operable to identify SORs 120 that contain unauthorized data attributes and correct the unauthorized data attributes in SORs 120, thereby replacing unauthorized data attributes with authorized data attributes. Master data module 110 may correct the unauthorized data attributes by replacing unauthorized data attributes with authorized data attributes, instructing SORs 120 with unauthorized data attributes to change the unauthorized data attributes to conform with corresponding authorized data attributes, or any other suitable process. In an embodiment, master data module 110 identifies SORs 120 with redundant data attribute values to determine SORs 120 that can be eliminated. Master data module 110 may monitor data quality metrics for SORs 120 and identify SORs 120 that need to be replaced based on the monitored data quality metrics.

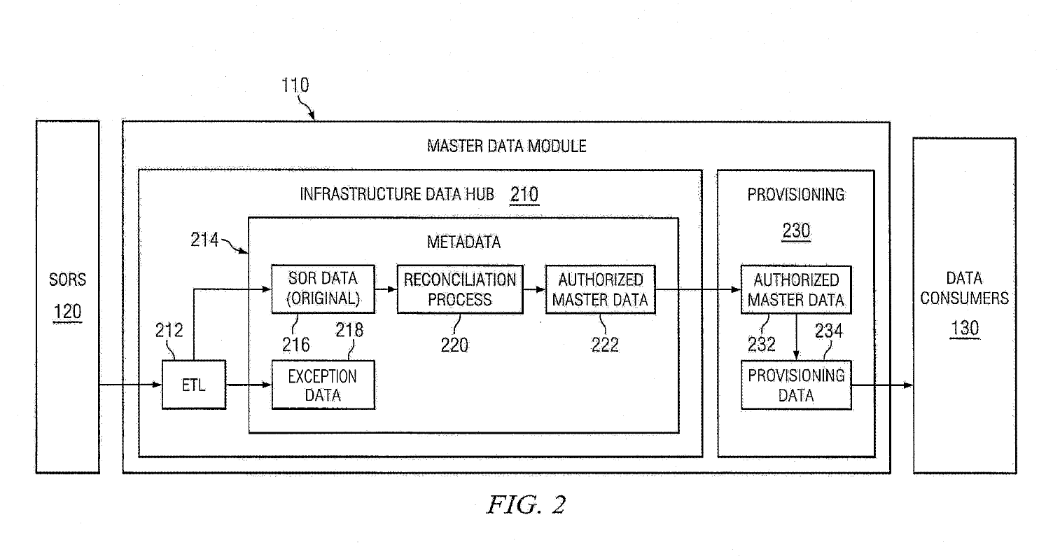

Master data module 110 may perform any suitable function for system 100, for example, data warehousing, data management, and data provisioning on platforms such as IBM DB2 Universal Database®, Microsoft SQL Server®, Oracle Relational Database Management System (RDBMS)®, IBM IIS® information server, IBM Netezza®, Oracle Exadata®, Teradata Data Warehouse®, Sybase IQ®, Greenplum Database®, Vertica Analytic Database®, Aster Data nCluster®, or any other suitable technology platform. In certain embodiments, master data module 110 includes one or more processors 112, interfaces 114, memories 116, and databases 118. An embodiment of master data module 110 is discussed in more detail in the description of FIG. 2.

SORs 120 represent platforms that maintain data attributes in system 100. Data attributes represent categories of data that hold data attribute values that may be provisioned to data consumers 130. Data attributes may include any component of a database of SORs 120, for example, a row, column, cell, or a portion of any of the preceding. Data attribute values represent any value in a data attribute. In certain embodiments, SORs 120 acquire, generate, and/or store data attributes for subdivisions of enterprise 150, and different subdivisions may have different asset management systems that have different formats for data attributes. In certain embodiments, multiple SORs 120 maintain different versions of the same, or similar, data attributes. In certain embodiments, SORs 120 include one or more processors 122, interfaces 124, memories 126, and databases 128.

Data consumers 130 represent entities that request data attribute values from data attributes maintained by SORs 120. Data consumers 130 may include persons, groups, organizations, business units, subdivisions of enterprise 150, SORs 120, applications, or other suitable entity. In certain embodiments, data consumers 130 are automated software applications. Data consumers 130 may communicate requests for data attribute values through one or more interfaces of master data module 110. In an embodiment, master data module 110 represents the sole provisioning point for data consumers 130 to access data attribute values from data attributes maintained by SORs 120. Data consumers 130 may communicate requests for data attribute values using one or more applications that provide a user interface to interact with master data module 110. In certain embodiments, data consumers 130 include one or more processors 132, interfaces 134, memories 136, and databases 138.

Data model authorities 140 represent persons, groups, organizations, systems, or other suitable entity with authority over a category of data attribute. Data model authorities 140 may determine criteria describing data quality requirements for a common data model for categories of data attributes or data attribute values. In certain embodiments, data quality requirements include data lineage (e.g., the transformation history of a data attribute or data attribute value), rules for identifying the best available data attribute or data attribute value (e.g., data reconciliation rules), network location of the data attribute or data attribute value, the common data model applied to the data attribute or data attribute value, or any other suitable information. In particular embodiments, the common data model for a category of data attribute is stored in, and enforced by, metadata associated with data attributes.

Metadata associated with data attributes may comprise active and/or passive metadata. In certain embodiments, active metadata comprises instructions executable by hardware or software of master data module 110 that instruct components of master data module 110 on how to process the data attributes. Passive metadata may provide descriptions of information required by the common data model to be maintained for data attributes or data attribute values, such as data lineage (e.g., the transformation history of a data attribute or data attribute value), rules for identifying the best available data attribute or data attribute value (e.g., data reconciliation rules), network location the data attribute or data attribute value, the common data model applied to the data attribute or data attribute value, or any other suitable information.

Enterprise 150 represents an entity that operates system 100. In an embodiment, enterprise 150 includes master data module 110, SORs 120, data consumers 130, data model authorities 140, and network 160. Enterprise 150 may refer to a business, government, non-profit organization, or any suitable type of entity that operates IT assets. Enterprise 150 may have different units or subdivisions that handle different activities of enterprise 150. Different subdivisions of enterprise 150 may operate various SORs 120 of system 100. In certain embodiments, one or more SORs 120, data consumers 130, or data model authorities are not part of enterprise 150.

Network 160 represents any suitable network operable to facilitate communication between components of system 100, such as master data module 110, SORs 120, data consumers 130, data model authorities 150, and enterprise 150. Network 160 may include any interconnecting system capable of transmitting audio, video, electrical signals, optical signals, data, messages, or any combination of the preceding. Network 160 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100.

A module (e.g., master data module 110) may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of a module may be performed by any suitable combination of one or more servers or other components at one or more locations. In embodiments where modules represent a server, the server may be a private server, and the server may be a virtual or physical server. Additionally, a module may include any suitable component that functions as a server.

Components of system 100, such as master data module 110, SORs 120, and data consumers 130, may include one or more processors. A processor represents any computing device, such as processors 112, 122, and 132, configured to control the operation of one or more components of system 100. A processor may comprise one or more processors and may be a programmable logic device, a microcontroller, a microprocessor, any suitable processing device, or any suitable combination of the preceding. A processor includes any hardware or software that operates to control and process information received by a component of system 100. In certain embodiments, a processor communicatively couples to other components of system 100, such as a module (e.g., master data module 110), an interface (e.g., interfaces 114, 124, and 134), a memory (e.g., memories 116, 126, and 136), a database (e.g., databases 118, 128, and 138), or any other suitable component.

An interface represents any device, such as interfaces 114, 124, and 134, operable to receive input, send output, process the input or output, or perform other suitable operations for a component of system 100. An interface includes any port or connection, real or virtual, including any suitable hardware or software, including protocol conversion and data processing capabilities, to communicate through network 160. In certain embodiments, an interface includes a user interface (e.g., physical input, graphical user interface, touchscreen, buttons, switches, transducer, or any other suitable method to receive input from a user).

A memory represents any device, such as memories 116, 126, and 136, operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 118, 128, and 138).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

In an embodiment of operation of system 100, master data module 110 receives criteria describing data quality requirements for a common data model for a particular category of data attributes from one or more data model authorities 140. A data category may be any suitable subdivision of data attributes maintained by SORs 120, for example, product pricing information. In certain embodiments, the one or more data model authorities 140 represent persons, groups, organizations, systems, or any other suitable entity having authority over one or more categories of data attributes.

A common data model represents a standardized data attribute format, and includes data quality requirements that describe information that must be maintained with respect to data attributes. Data quality requirements may include data lineage (e.g., the transformation history of a data attribute or data attribute value), rules for reconciling different versions of a data attribute or data attribute value (e.g., data reconciliation rules), network location of the data attribute, the common data model associated with the data attribute, or any other suitable information. In particular embodiments, metadata associated with data attributes maintains the information required by the common data model.

Master data module 110 may receive data attributes from one or more SORs 120 for a category of data. In an embodiment, master data module 110 identifies the best available data attributes in the SORs 120 using criteria contained within the common data model. In certain embodiments, different SORs 120 maintain different versions of the same data attributes. Master data module 110 may apply criteria described by the common data model to reconcile competing versions of a data attribute or a data attribute value. Master data module 110 may designate the best available data attributes as authorized for provisioning, for example, by identifying the data attributes as authorized in metadata for the data attributes. In certain embodiments, master data module 110 receives requests for data attribute values from one or more data consumers 130, and provisions data attribute values to the data consumers 130 from authorized data attributes in response to the requests.

Master data module 110 may represent a single provisioning point for data attributes maintained by SORs 120. For example, data consumers 130 may only be able to access data attribute values from data attributes maintained by SORs 120 by requesting the data attribute values from master data module 110 thereby ensuring consistent provisioning of data attribute values to all data consumers 130. Because master data module 110 may represent the sole provisioning point for data attributes maintained by SORs 120, master data module 110 is operable to enforce a common data model for one or more categories of data attributes to ensure that only data attributes values that comply with the common data model are provisioned to data consumers 130 from SORs 120. In this way, master data module 110 can prevent the distribution of unauthorized data attribute values to data consumers 130.

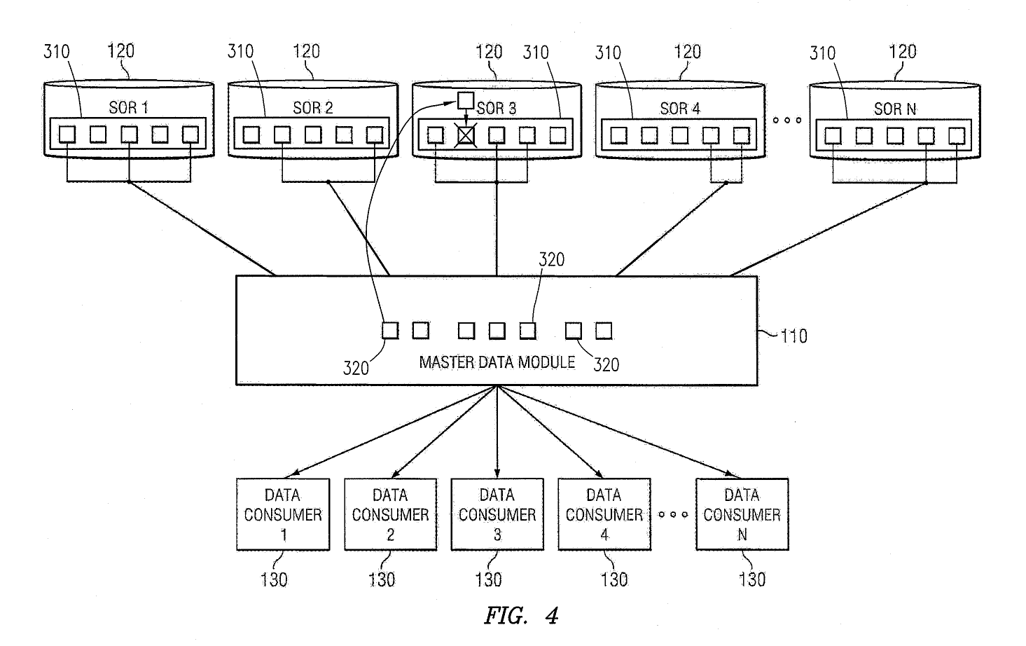

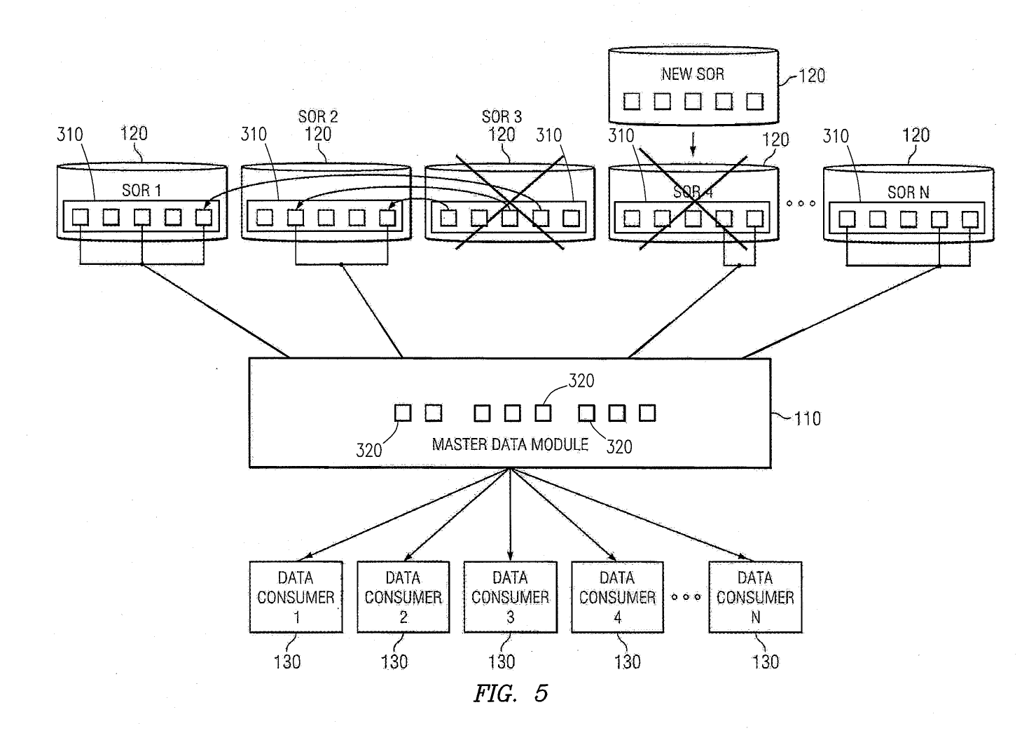

In certain embodiments, master data module 110 identifies and corrects unauthorized versions of data attributes in SORs 120. This functionality of master data module 110 is explained in more detail below with respect to FIG. 4. Master data module 110 may identify SORs 120 that maintain redundant versions of data attribute values, thereby identifying SORs 120 that can be eliminated. In an embodiment, master data module 110 may evaluate the competency of SORs 120 to comply with data quality standards to identify SOR 120 platforms that are in need of replacement. These functionalities of master data module 110 are explained in more detail below with respect to FIG. 5.

Modifications, additions, or omissions may be made to system 100. System 100 may include more, fewer, or other components. Any suitable component of system 100 may include a processor, interface, logic, memory, or other suitable element.

FIG. 2 is a block diagram illustrating an embodiment of a platform for providing centralized data provisioning. Master data module 110 may be communicatively coupled to SORs 120 and data consumers 230. In the illustrated embodiment, master data module 110 includes infrastructure data hub 210 which includes extract-transform-load (ETL) block 212, metadata 214, and provisioning block 230. Metadata 214 may perform functions such as identifying non-exception SOR data attributes (block 216), identifying exception SOR data attributes (block 218), applying reconciliation rules from a common data model to identify the best available data attributes in SORs 120 (block 220), designating data attributes as authorized for provisioning (block 222), or any other suitable functionality.

In the illustrated embodiment, master data module 110 receives data attributes from SORs 120 at ETL block 212. For example, data attributes received from SORs 120 may be loaded into an interface table for processing. The ETL block 212 may identify exceptions in the received data attributes, for example, data attributes that do not have unique natural keys or reconciliation keys. Keys may represent unique identification features, for example serial number of the server holding the data, customer social security number, product model number, or any other data feature that can be used to identify corresponding data attribute values from different data attributes. Exception data attributes may be designated as exceptions in metadata for the data attributes at exception block 218. In certain embodiments, non-exception data attributes are designated as non-exceptions in metadata for the data attributes at SOR data at block 216.

Multiple different data attributes from different SORs 120 may be different versions of the same data attribute. In certain embodiments, different data attribute versions exist because similar information is utilized by different subdivisions of enterprise 150 and SORs 120 for different subdivisions may utilize different data attribute formats. In certain embodiments, master data module 110 selects the best available data attributes by applying reconciliation rules described by the common data model to the competing data attributes at block 220. Master data module 110 designates the selected data attribute as authorized for provisioning at block 222. The data attributes authorized for provisioning are moved to the provisioning block 230 of master data module 110 at block 232. At block 234, the authorized data attributes are provisioned to data consumers 130.

In certain embodiments, master data module 110 identifies unauthorized data attributes in SORs 120, and corrects the unauthorized data attributes in SORs 120. Master data module 110 may correct the unauthorized data attributes by provisioning authorized data attributes to SORs 120 to replace the unauthorized data attributes, instructing SORs 120 with unauthorized data attributes to change the unauthorized data attributes to conform with corresponding authorized data attributes, or any other suitable process. Master data module 110 may identify different SORs 120 that maintain similar data attribute values to identify SORs 120 that may be eliminated. In an embodiment, master data module 110 selects components from different data attributes based on reconciliation rules and integrates the selected components to generate an authorized data attribute for provisioning.

Master data module 110 may provide any number of functionalities for system 100. For example, master data module 110 may provide data warehousing, data management, data provisioning, or any other suitable function for system 100. In certain embodiments, master data module 110 provides data warehousing functionality using IBM DB2®, Microsoft SQL Server®, Oracle Relational Database Management System (RDBMS)®, or any other suitable database platform. Master data module 110 may provide data management functionality using IBM IIS® information server, Informatica®, MS SQL® server integration services, or any other suitable platform. In an embodiment, master data module 110 provides data provisioning functionality using IBM Netezza®, Oracle Exadata®, Teradata Data Warehouse®, Sybase IQ®, Greenplum Database®, Vertica Analytic Database®, Aster Data nCluster®, or any other suitable platform.

Modifications, additions, or omissions may be made to master data module 110. Master data module 110 may include more, fewer, or other components. Any suitable component of master data module 110 may include a processor, interface, logic, memory, or other suitable element. Master data module 110 may perform more, fewer, or other functions. Additionally, functions may be performed in any suitable order. Any suitable component of system 100 may perform one or more of the functionalities of master data module 110.

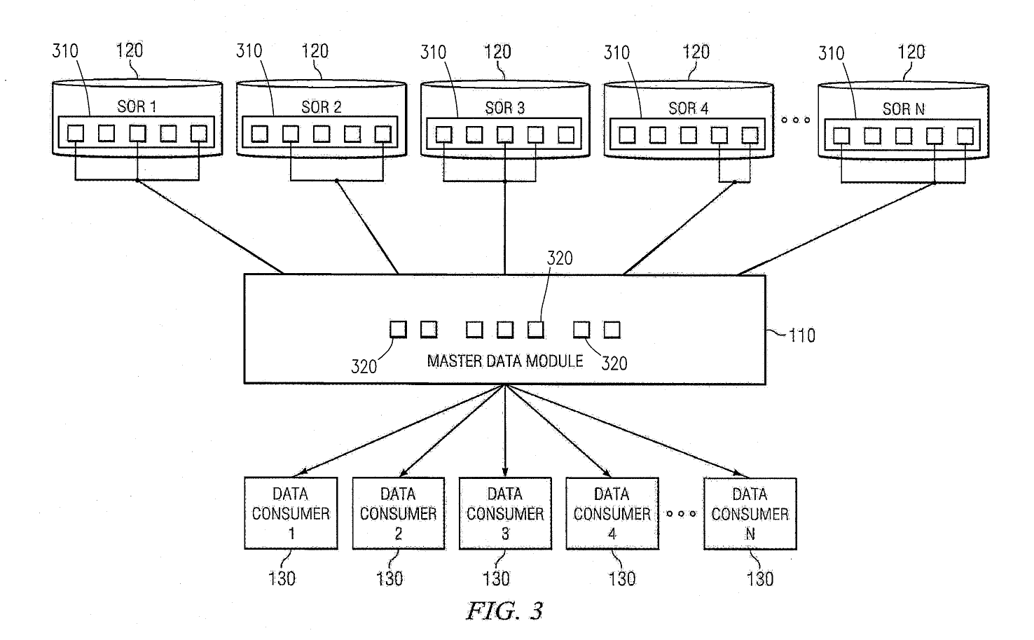

FIG. 3 is a block diagram illustrating an embodiment of a system for selecting and provisioning data attribute values to data consumers. In the illustrated embodiment, master data module 110 is communicatively coupled to a plurality of SORs 120 and a plurality of data consumers 130. Each SOR 120 maintains a plurality of data attributes 310. Master data module 110 may receive data attributes 310 from one or more SORs 120. In certain embodiments, master data module 110 evaluates the received data attributes 310 in SORs 120 based on criteria described in a common data model for the data attributes to determine the best available data attributes and authorizes the best available data attributes for provisioning. The received data attributes 310 may represent the same, or similar, data attributes 310 (e.g., columns from different databases holding the same type of data values). In certain embodiments, master data module 110 collates the received data attributes 310 into an authorized data attribute 320.

In an embodiment, master data module 110 maintains directory information of SORs 120 that maintain authorized data attributes 320. For example, master data module 110 may only store directory information for authorized data attributes 320 and may not maintain a database of authorized data attributes 320 at master data module 110. In an embodiment, data consumers 130 communicate requests to master data module 110 for data attributes 310 maintained by SORs 120.

Master data module 110 may represent the sole provisioning point for data consumers 130 to request data attributes 310 maintained by SORs 120. By requiring data consumers 130 to access SORs 120 through master data module 110, master data module 110 is operable to force data attributes 310 to comply with common data models before data attribute values are provisioned to data consumers 130. Because only data attribute values from authorized data attributes 320 can be distributed to data consumers 130, master data module 110 ensures consistent data attribute value provisioning across all data consumers and prevents defective data attribute values from propagating downstream from SORs 120.

Modifications, additions, or omissions may be made to the system. The system may include more, fewer, or other components. Any suitable component of the system may include a processor, interface, logic, memory, or other suitable element. In certain embodiments, master data module 110 may store data attributes 310, for example authorized data attributes 320 or unauthorized data attributes 310, at the master data module 110.

FIG. 4 is a block diagram illustrating an embodiment of a system for identifying and correcting unauthorized data attributes. As discussed above with respect to FIG. 3, master data module 110 may evaluate data attributes 310 to identify authorized data attributes 320 that are approved for provisioning. In the illustrated embodiment, master data module 110 is operable to provision data attribute values from authorized data attributes 320 to SORs 120 that maintain unauthorized data attributes 310. For example, master data module 110 may identify that SOR1 120 maintains an authorized data attribute 320 that corresponds to an unauthorized data attribute 310 maintained by SOR3 120. In an embodiment, master data module 110 provisions the authorized data attribute 320 from SOR1 120 to SOR3 120. SOR3 120 may replace the unauthorized data attribute 310 with the authorized data attribute 320. Master data module 110 may correct unauthorized data attributes 310 by instructing the SOR 120 maintaining the unauthorized data attribute 310 to fix the unauthorized data attribute 310 to conform to the authorized data attribute 320. By identifying SORs 120 that maintain unauthorized data attributes 310 that have corresponding authorized data attributes 320 maintained by other SORs 120, master data module 110 is able to correct defective data attributes across SORs 120. In certain embodiments, master data module 110 is operable to automatically identify SORs 120 with unauthorized data attributes 310 and provision corresponding authorized data attributes 320 to those SORs 120.

Modifications, additions, or omissions may be made to the system. The system may include more, fewer, or other components. Any suitable component of the system may include a processor, interface, logic, memory, or other suitable element.

FIG. 5 is a block diagram illustrating an embodiment of a system for identifying databases that can be eliminated or replaced. As discussed above with respect to FIG. 3, master data module 110 may evaluate data attributes 310 to identify authorized data attributes 320 that are approved for provisioning. In certain embodiments, master data module 110 is operable to identify SORs 120 that maintain duplicative data attributes 310. Duplicative data attributes 310 may be authorized data attributes 320 or unauthorized data attributes 310. In the illustrated embodiment, master data module 110 determines that data attribute values in authorized data attributes 320 maintained by SOR3 120 are duplicative of data attribute values in authorized data attributes 320 maintained by SOR1 120 and SOR2 120. The remaining unauthorized data attributes 310 may not be necessary to maintain, for example, because authorized data attributes 320 corresponding to the unauthorized data attributes 310 are maintained by other SORs 120. In an embodiment, master data module 110 determines that, because data attributes 310 maintained by SOR3 120 are either duplicative or unnecessary, SOR3 120 may be eliminated. By identifying SOR 120 platforms that may be eliminated, master data module 110 can reduce the costs associated with maintaining IT infrastructures and reduce network complexity. In certain embodiments, removing or replacing SORs 120 does not affect, and may not be visible to, data consumers 130 because master data module 110 represents the sole provisioning point for data attribute values maintained by SORs 120. When SORs 120 are removed or replaced, master data module 110 can ensure that the authorized data attributes 320 of the removed or replaced SOR 120 are replicated in other SORs 120. In this way, SORs 120 can be easily replaced, removed, or changed without affecting downstream data consumers 130.

Master data module 110 may be operable to evaluate SOR 120 technology platform performance. For example, because master data module 110 is connected to a plurality of SORs 120, it may monitor data quality metrics associated with each SOR 120. In the illustrated embodiment, master data module 110 determines that SOR4 120 does not satisfy data quality requirements, and needs to be replaced with new SOR 120. By identifying SORs 120 that do not satisfy data quality requirements, master data module 110 can identify platforms that need to be replaced. In an embodiment, master data module 110 is operable to identify platforms with superior data quality metrics. In this way, master data module 110 can evaluate SORs 120 and direct the resources of IT systems to high performance SORs 120.

Modifications, additions, or omissions may be made to the system. The system may include more, fewer, or other components. Any suitable component of the system may include a processor, interface, logic, memory, or other suitable element.

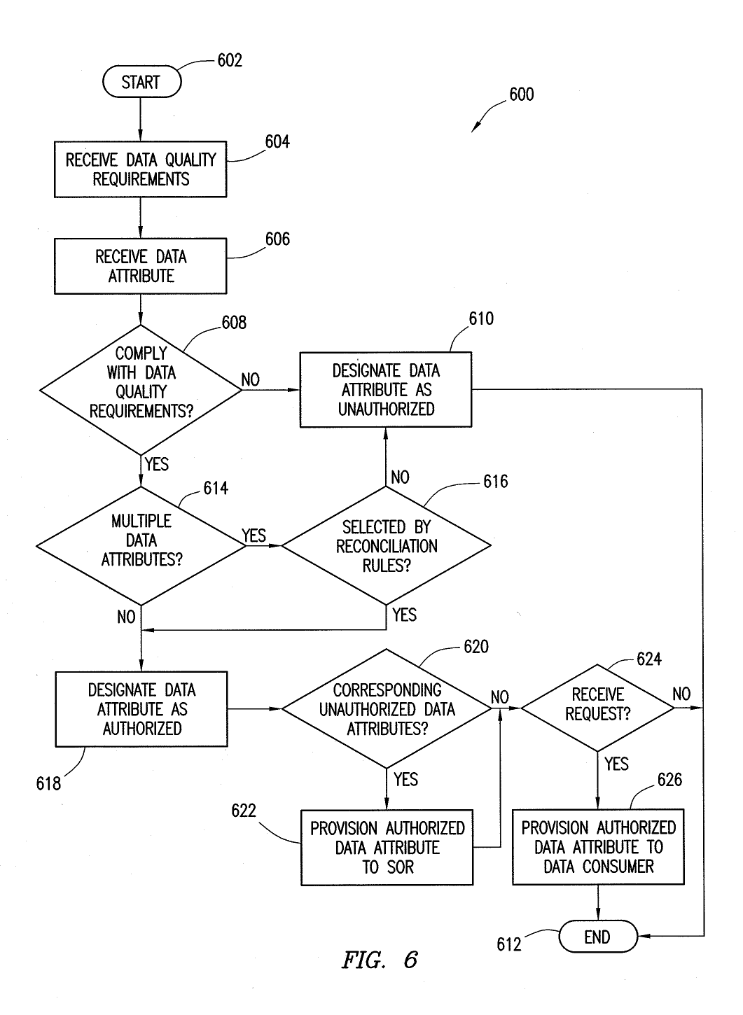

FIG. 6 is a flow chart of an embodiment of a method for providing centralized data provisioning Method 600 starts at step 602. At step 604, master data module 110, receives criteria describing data quality requirements for a common data model for a category of data attribute. The common data model may include data quality requirements such as data lineage (e.g., the transformation history of a data attribute), rules for identifying the best available data attribute (e.g., data reconciliation rules), network location the data attribute, the common data model applied to the data attribute, or any other suitable information.

At step 606, master data module 110 receives a data attribute from SOR 120. At step 608, master data module 110 determines whether the data attribute complies with data quality requirements of a common data model for the data attribute. If the data attribute does not comply with the data quality requirements, the master data module 110 designates the data attribute as unauthorized for provisioning, for example, in metadata for the data attribute, and the method ends at step 612. If the data attribute complies with the data quality requirements of the common data model, master data module 110 determines whether there are multiple versions of the data attribute that comply with the common data model. If there are multiple versions of the data attribute that comply with the common data model, at step 616 master data module 110 applies rules of reconciliation from the common data model to identify the best available data attribute. If the data attribute is not selected, the method continues to step 610 and the data attribute is designated as unauthorized for provisioning. If the data attribute is selected, the method continues to the step 618 and the data attribute is designated as authorized for provisioning.

At step 620, master data module 110 determines whether SORs 120 maintain unauthorized versions of the authorized data attribute. If master data module 110 determines that one or more SORs 120 maintain unauthorized versions of the authorized data attribute, master data module 110 provisions the authorized data attribute to the one or more SORs 120 to correct the unauthorized data attributes at step 622 and the method continues to step 624. If master data module 110 determines that no SORs 120 maintain unauthorized versions of the authorized data attribute, the method continues to step 624. At step 624, master data module 110 determines whether a request for a data attribute value from the authorized data attribute has been received from a data consumer 130. If no request has been received, the method ends at step 612. If a request has been received, master data module 110 provisions the requested data attribute value from the authorized data attribute to the requesting data consumer 130 and the method ends at step 612.

Modifications, additions, or omissions may be made to method 600. The method may include more, fewer, or other steps. Additionally, steps may be performed in any suitable order. Any suitable component of system 100 may perform one or more steps of method 600.

Certain embodiments of the present disclosure may include some, all, or none of the following advantages. One or more other technical advantages may be readily apparent to those skilled in the art from the figures, descriptions, and claims included herein.

In an embodiment, a single provisioning platform receives criteria describing a common data model for categories of data attributes maintained by different sources-of-record (SORs), thereby conserving the computational resources, memory, and bandwidth consumed by provisioning from data attributes that have not been standardized to a common data model.

In another embodiment, a single provisioning platform enforces a common data model by only provisioning from data attributes that satisfy the data quality requirements of the common data model, thereby conserving the computational resources, memory, and bandwidth consumed by provisioning from data attributes that do not satisfy the data quality requirements.

In yet another embodiment, a single provisioning platform enforces a common data model for provisioning from data attributes that includes rules for reconciling multiple data attributes (or data attribute values) that satisfy the data quality requirements of the common data model, thereby conserving the computational resources, memory, and bandwidth consumed by provisioning from different versions of data attributes.

In a further embodiment, a single provisioning platform is operable to identify and correct SORs that maintain unauthorized versions of data attributes, thereby conserving the computational resources, memory, and bandwidth consumed by maintaining and provisioning from unauthorized versions of data attributes.

In a still further embodiment, a single provisioning platform is operable to evaluate the competency of SORs to satisfy data quality requirements to identify SORs in need of replacement, thereby conserving the computational resources, memory, and bandwidth consumed by maintaining SOR platforms that do not satisfy data quality requirements.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A system for provisioning data on an electronic communication network, comprising:
one or more interfaces of a provisioning platform operable to:
receive criteria describing data quality requirements for a data attribute category, wherein the provisioning platform represents the sole provisioning platform for requests for data attribute values maintained by a plurality of databases; and
receive a data attribute in the data attribute category from one of the plurality of databases;
one or more processors of the provisioning platform operable to:
determine whether the received data attribute complies with the data quality requirements;
designate the data attribute as authorized for provisioning in response to determining that the data attribute complies with the data quality requirements; and
designate the data attribute as unauthorized for provisioning in response to determining that the data attribute does not comply with the data quality requirements; and
the one or more interfaces of the provisioning platform further operable to:
receive a request to provision a data attribute value from the data attribute; and
provision the data attribute value in response to the data request if the data attribute is designated as authorized for provisioning.

2. The system of claim 1, the one or more processors further operable to:
determine that multiple versions of the data attribute comply with the data quality requirements; and
apply reconciliation rules to the multiple versions of the data attribute to select a single version of the data attribute to designate as authorized, wherein the reconciliation rules are required to be associated with the data attribute by the data quality requirements.

3. The system of claim 1, the one or more processors further operable to:
identify unauthorized versions of the data attribute in one or more of the plurality of databases in response to determining that the data attribute complies with the data quality requirements; and
correct the unauthorized versions of the data attribute in the one or more of the plurality of databases with unauthorized versions of the data attribute.

4. The system of claim 1, the one or more processors further operable to:
determine that two or more of the databases contain duplicative data attributes; and
select at least one of the two or more databases to be eliminated.

5. The system of claim 1, wherein data quality requirements are part of a common data model for the data attribute category.

6. The system of claim 1, wherein the data quality requirements include at least one from the set comprising:
a data lineage for the data attribute;
a description of data quality requirements for the data attribute; and
instructions for reconciling multiple data attributes.

7. The system of claim 1, wherein the data quality requirements are stored in metadata associated with the data attribute, the metadata comprising:
active metadata executable by a processor that provides processing instructions for the data attribute; and
passive metadata that provides description of the common data model.

8. A non-transitory computer readable storage medium comprising logic for provisioning data on an electronic communication network, the logic operable, when executed by a processor, to:
receive, at a provisioning platform for a plurality of databases, criteria describing data quality requirements for a data attribute category, wherein the provisioning platform represents the sole provisioning platform for requests for data attribute values maintained by a plurality of databases;
receive, at the provisioning platform, a data attribute in the data attribute category from one of the plurality of databases;
determine, by the provisioning platform, whether the received data attribute complies with the data quality requirements;
designate, by the provisioning platform, the data attribute as authorized for provisioning in response to determining that the data attribute complies with the data quality requirements;
designate, by the provisioning platform, the data attribute as unauthorized for provisioning in response to determining that the data attribute does not comply with the data quality requirements;
receive, at the provisioning platform, a request to provision a data attribute value from the data attribute; and
provision, by the provisioning platform, the data attribute value in response to the data request if the data attribute is designated as authorized for provisioning.

9. The non-transitory computer readable storage medium of claim 8, the logic further operable to:
determine, by the provisioning platform, that multiple versions of the data attribute comply with the data quality requirements; and
apply, by the provisioning platform, reconciliation rules to the multiple versions of the data attribute to select a single version of the data attribute to designate as authorized, wherein the reconciliation rules are required to be associated with the data attribute by the data quality requirements.

10. The non-transitory computer readable storage medium of claim 8, the logic further operable to:
identify, by the provisioning platform, unauthorized versions of the data attribute in one or more of the plurality of databases in response to determining that the data attribute complies with the data quality requirements; and
correct, by the provisioning platform, the unauthorized versions of the data attribute in the one or more of the plurality of databases with unauthorized versions of the data attribute.

11. The non-transitory computer readable storage medium of claim 8, the logic further operable to:
determine, by the provisioning platform, that two or more of the databases contain duplicative data attributes; and
selecting, by the provisioning platform, at least one of the two or more databases to be eliminated.

12. The non-transitory computer readable storage medium of claim 8, wherein the data quality requirements include at least one from the set comprising:
a data lineage for the data attribute;
a description of data quality requirements for the data attribute; and
instructions for reconciling multiple data attributes.

13. The non-transitory computer readable storage medium of claim 8, wherein the data quality requirements are stored in metadata associated with the data attribute, the metadata comprising:
active metadata executable by a processor that provides processing instructions for the data attribute; and
passive metadata that provides description of the common data model.

14. A method for provisioning data on an electronic communication network, comprising:
receiving, at a provisioning platform for a plurality of databases, criteria describing data quality requirements for a data attribute category, wherein the provisioning platform represents the sole provisioning platform for requests for data attribute values maintained by the plurality of databases;
receiving, at the provisioning platform, a data attribute in the data attribute category from one of the plurality of databases;
determining, by the provisioning platform, whether the received data attribute complies with the data quality requirements;
designating, by the provisioning platform, the data attribute as authorized for provisioning in response to determining that the data attribute complies with the data quality requirements;
designating, by the provisioning platform, the data attribute as unauthorized for provisioning in response to determining that the data attribute does not comply with the data quality requirements;
receiving, at the provisioning platform, a request to provision a data attribute value from the data attribute; and
provisioning, by the provisioning platform, the data attribute value in response to the data request if the data attribute is designated as authorized for provisioning.

15. The method of claim 14, further comprising:
determining, by the provisioning platform, that multiple versions of the data attribute comply with the data quality requirements; and
applying, by the provisioning platform, reconciliation rules to the multiple versions of the data attribute to select a single version of the data attribute to designate as authorized, wherein the reconciliation rules are required to be associated with the data attribute by the data quality requirements.

16. The method of claim 14, further comprising:
identifying, by the provisioning platform, unauthorized versions of the data attribute in one or more of the plurality of databases in response to determining that the data attribute complies with the data quality requirements; and
correcting, by the provisioning platform, the unauthorized versions of the data attribute in the one or more of the plurality of databases with unauthorized versions of the data attribute.

17. The method of claim 14, further comprising:
determining, by the provisioning platform, that two or more of the databases contain duplicative data attributes; and
selecting, by the provisioning platform, at least one of the two or more databases to be eliminated.

18. The method of claim 14, wherein data quality requirements are part of a common data model for the data attribute category.

19. The method of claim 14, wherein the data quality requirements include at least one from the set comprising:
a data lineage for the data attribute;
a description of data quality requirements for the data attribute; and
instructions for reconciling multiple data attributes.

20. The method of claim 14, wherein the data quality requirements are stored in metadata associated with the data attribute, the metadata comprising:
active metadata executable by a processor that provides processing instructions for the data attribute; and
passive metadata that provides description of the common data model.
